(19) United States
(12) Patent Application Publication
(10) Pub. No.: US 2026/0356007 A1
(43) Pub. Date: Nov. 12, 2026

(54) Methods of Pelletizing or Briquetting Polymer Solids

(71) Applicant: ExxonMobil Chemical Patents Inc., Spring, TX (US)

(72) Inventor: Stephen E. DEHLINGER, Seabrook, TX (US)

(21) Appl. No.: 19/102,985

(22) PCT Filed: Jul. 26, 2023
(86) PCT No.: PCT/US2023/070995

§ 371 Date: Feb. 11, 2025

Related U.S. Application Data
(60) Provisional application No. 63/373,121, filed on Aug. 22, 2022.

(51) Int. Cl. B29B 9/08; B29B 7/14; B29B 9/06; B29B 9/12; C08F 210/02

(52) U.S. Cl. CPC B29B 9/08; B29B 7/14; B29B 9/065; B29B 9/12; C08F 210/02

(57) ABSTRACT

The present disclosure generally relates to methods of pelletizing polymer solids. In at least one embodiment, a process for preparing a polymer pellet or a polymer briquette includes introducing a monomer, a catalyst, and a diluent into a reactor under polymerization conditions to form a granular polymer. The method includes introducing the polymer to a finishing device selected from the group consisting of a pellet mill, a rolling mill, a briquetter, or a combination thereof to form the polymer pellet or the polymer briquette without fully melting the granular polymer.

### CROSS-REFERENCE TO RELATED APPLICATION

This application claims the benefit of U.S. Provisional Application Number 63/373,121 filed Aug. 22, 2022, entitled “Methods of Pelletizing or Briquetting Polymer Solids”, the entirety of which is incorporated by reference herein.

### FIELD

The present disclosure generally relates to methods of pelletizing or briquetting polymer solids.

### BACKGROUND

Commercial polymer manufacturing processes typically utilize a pelletizing system where polymer solids (e.g. granules, powders, resin) are melted and pushed through a die plate containing many capillaries. The molten polymer is typically cut with a pelletizer knife and quenched to solidify the polymer into a shape typically called a pellet. This pelletization process works well but requires a significant amount of energy to melt the polymer and mix the additives in the polymer. The machines used for pelletization are typically very large, have very high energy usage, and utilize extensive support systems to make the pellet. This energy is then removed in the quench system which requires a large amount of cooling water and typically flows through a large cooling tower. The quench system also has an elaborate system of tanks, filters, heat exchangers, piping, and centrifugal dryers(s).

In fact, an extruder system for pelletization consumes the most energy of any other component in a polymerization reactor system. Some extruder systems (including water quench systems for underwater pelletizing) can utilize 23,000 horse power (Fd/t). In particular, for every one ton of polymer produced, 10-20 tons of water are used (consumed by evaporation, bleeds and overflows). The water used is recirculated and reused with a 3-4% water loss per hour, and a cooling tower is used which results in lost energy.

In addition, although extruder systems provide mixing of additives with the polymer being extruded, conventional extruders have to melt the polymer being processed (e.g., to 200-250 °C) in order to move the polymer through the die of a die plate. However, melting the polymer is performed using significant thermal energy which can compromise the integrity of the chemical structure of the polymer (and/or additives) being processed.

There is a need for polymerization processes and systems that provide improved integrity of the chemical structure of pelletized polymers (and/or additives), reduced water usage, and reduced energy consumption.

References of potential interest in this regard include: GB 2093052A; EP 1851023; U.S. Pat. No. 4,028,035; U.S. Pat. No. 5,176,751; EP 1824909; U.S. Pat. No. 5,879,720; EP 698461; EP 2864104; U.S. Pat. No. 5,072,887; U.S. 2006/0110485; U.S. Pat. No. 5,263,817; U.S. Pub. No. 2021/0079125; U.S. 2005/0230872.

### SUMMARY

The present disclosure generally relates to methods of pelletizing or briquetting polymer solids.

In at least one embodiment, a process for preparing a polymer pellet or a polymer briquette includes introducing a monomer, a catalyst, and a diluent into a reactor under polymerization conditions to form a polymer. The method includes introducing the polymer to a finishing device selected from the group consisting of a pellet mill, a rolling mill, a briquetter, or a combination thereof to form the polymer pellet or the polymer briquette.

### BRIEF DESCRIPTION OF THE DRAWINGS

FIG. 1A is a diagram of an apparatus, according to an embodiment.

FIG. 1B is a diagram of an apparatus, according to an embodiment.

FIG. 1C illustrates a recycle recovery unit, according to an embodiment.

FIG. 2A illustrates a pellet mill, according to an embodiment.

FIG. 2B illustrates a pellet mill, according to an embodiment.

FIG. 3A illustrates a briquetter, according to an embodiment.

FIG. 3B illustrates a briquetter, according to an embodiment.

FIG. 3C illustrates a briquetter, according to an embodiment.

FIG. 3D illustrates a briquetter, according to an embodiment.

FIG. 4 illustrates a rolling mill, according to an embodiment.

FIG. 5 illustrates a stack of assembled roller pairs, according to an embodiment.

FIG. 6 illustrates a stack of assembled roller pairs, according to an embodiment.

FIG. 7 illustrates bearings for rolls, according to an embodiment.

FIG. 8 illustrates a roll adjustment device, according to an embodiment.

FIG. 9 illustrates a shaft mounted gear box, according to an embodiment.

FIG. 10 illustrates a shaft mounted gear box, according to an embodiment.

FIG. 11 illustrates a shaft mounted gear box, according to an embodiment.

FIG. 12 illustrates a belt tensioning device, according to an embodiment.

FIG. 13 illustrates a belt tensioning device, according to an embodiment.

FIG. 14 illustrates a belt tensioning device, according to an embodiment.

FIG. 15 illustrates a conventional twin screw extruder and underwater pelletizer, according to an embodiment.

### DETAILED DESCRIPTION

The present disclosure generally relates to methods of pelletizing or briquetting in 5 polymer solids.

Processes and polymerization reactor systems of the present disclosure can take granular products from a reactor uniformly distribute additives therewith and form pellets for distribution and further use as polymer products. The polymer from a reactor (and/or one or more separation systems) feeds into a finishing device (e.g., a pellet mill, a briquetter, tableter, or a rolling mill) which will extrude with pressure and without substantial (e.g., complete) melting of the polymer through a capillary. As the product flows through a capillary it can be cut or broken to a desired shape. Such processes are designed to compact the product without fully melting the solid. Briquetting machines may also be used to compact the product into a shape directly without flow through a capillary. In some cases, the outside surface of a pellet or briquette may be subjected to sintering to increase the strength and reduce the brittleness of the pellet/briquette. A briquette can be larger than a pellet. In some embodiments, a briquette or pellet of the present disclosure can be about 4 mm diameter by 4 mm length +/−30%. In some embodiments, a pellet has a diameter of about 2.6 mm to about 4.5 mm. In some embodiments, a pellet has a length of about 2 mm to about 8 mm.

The inventors have found that by utilizing compaction, briquetting, and/or sintering of polymer solids (e.g., polymer product such as granules from a polymerization reactor system, or other solid polymer particles such as mechanically recycled polymer solids), polymer solids can be pelletized with a large reduction in energy usage (e.g., 80% reduction or more) while maintaining an ability to incorporate additives into the polymer pellet (e.g., maintaining 80-90% mixing efficiency as compared to an extruder). In addition, because the polymer solid is preferably not taken to a melt phase (unlike with conventional extruders), the integrity of the chemical structure of the polymer itself (and/or additives) is maintained due to reduced thermal stresses on the polymer (and/or additives) as compared to conventional extruders utilizing a polymer melt. In the case of additives, a reduced amount of additives may be used due to the reduced degradation of the additives in processes and polymerization reactor systems of the present disclosure. Also, due to the reduced thermal input, a reduced or eliminated amount of nitrogen can be used in processes of the present disclosure due to reduced oxidation of polymer and/or additives which provides reduced discoloration (e.g., yellowness) of the polymer products. Additionally the use of water can be virtually eliminated in removing heat normally related to re-solidification after melting.

It has also been discovered that processes and polymerization reactor systems of the present disclosure may be particularly advantageous for polymerization and solidification of polymers that are suitable for downstream injection molding or blow molding processes because, in such processes, gel formation is not particularly important because thick-walled products can be formed from the injection molding and/or blow molding. For example, processes of the present disclosure can provide blow molded products such as jugs, shampoo bottles, bottle caps, kayaks, blow molded furniture, among others.

Processes and polymerization reactor systems of the present disclosure also provide less water and fines in plant sewer sumps (from overflow removal of water).

In addition, as compared to plastic recycle processes using consumer recycle plastic, processes of the present disclosure utilizing compaction, briquetting, and/or sintering of polymer solids provide less dust, more precise addition of additives, and a higher bulk density as compared to compaction, briquetting, and/or sintering of consumer recycle plastic.

As mentioned above, methods of the present disclosure can provide a polymer, such as a polymer suitable for injection molding or blow molding. In some embodiments, a polymer has a density of about 0.88 g/cm³ to about 0.98 g/cm³ . In some embodiments, a polymer is a high density polyethylene (HDPE). Density can be determined according to ASTM D792.Specimens can be prepared according to ASTM D4703—Annex 1 Procedure C followed by conditioning according to ASTM D618—Procedure A prior to testing.

Polymerization reactions of the present disclosure can be performed in any suitable reactor under any suitable conditions such as gas phase, solution or slurry polymerization conditions. A stirred polymerization reactor can be utilized for a batch or continuous process, or the polymerization reaction can be carried out continuously in a loop reactor.

For the purposes of this disclosure, the following definitions apply:

The terms “a” and “the” as used herein are understood to encompass the plural as well as the singular.

The term “catalyst system” may include one or more polymerization catalysts, activators, supports/carriers, or any combination thereof.

The term “comonomer” refers to the unique mer units in a copolymer. The composition of the copolymer varies at different molecular weights.

The term “copolymer” refers to polymers having more than one type of monomer, including interpolymers, terpolymers, or higher order polymers.

All numerical values within the detailed description and the claims herein are modified by “about” or “approximately” the indicated value, taking into account experimental error and variations.

The term “metallocene catalyst” refers to a catalyst having at least one transition in 5 metal compound containing one or more substituted or unsubstituted cyclopentadienyl (Cp) moiety (typically two Cp moieties) in combination with a Group 4, 5, or 6 transition metal. A metallocene catalyst is considered a single site catalyst. Metallocene catalysts generally require activation with a suitable co-catalyst, or activator, in order to yield an “active metallocene catalyst”, i.e., an organometallic complex with a vacant coordination site that can coordinate, insert, and polymerize olefins. Active catalyst systems generally include not only the metallocene complex, but also an activator, such as an alumoxane or a derivative thereof (such as methyl alumoxane), an ionizing activator, a Lewis acid, or a combination thereof. Alkylalumoxanes (such as methyl alumoxane and modified methylalumoxanes) are particularly suitable as catalyst activators. The catalyst system can be supported on a carrier, typically an inorganic oxide or chloride or a resinous material such as, for example, polyethylene or silica. When used in relation to metallocene catalysts, the term “substituted” means that a hydrogen group has been replaced with a hydrocarbyl group, a heteroatom, or a heteroatom containing group. For example, methylcyclopentadiene is a Cp group substituted with a methyl group.

As used herein, the term “olefin” refers to a linear, branched, or cyclic compound comprising carbon and hydrogen and having a hydrocarbon chain containing at least one carbon-to-carbon double bond in the structure thereof, where the carbon-to-carbon double bond does not constitute a part of an aromatic ring. The term olefin includes all structural isomeric forms of olefins, unless it is specified to mean a single isomer or the context clearly indicates otherwise.

The term “alpha-olefin” or “α-olefin” refers to an olefin having a terminal carbon-to-carbon double bond in the structure thereof (R¹R²)—C═CH₂, where R¹ and R² can be independently hydrogen or any hydrocarbyl group. In an aspect, R¹ is hydrogen, and R² is an alkyl group. A “linear alpha-olefin” is an alpha-olefin as defined in this paragraph wherein R¹ is hydrogen, and R² is hydrogen or a linear alkyl group.

As used herein, the term “polymer” refers to a compound having two or more of the same or different “mer” units. A “homopolymer” is a polymer having mer units that are the same. A “copolymer” is a polymer having two or more mer units that are different from each other. A “terpolymer” is a polymer having three mer units that are different from each other. “Different” in reference to mer units indicates that the mer units differ from each other by at least one atom or are different isomerically.

As used herein, when a polymer or copolymer is referred to as comprising an olefin, the olefin present in such polymer or copolymer is the polymerized form of the olefin. For in 5 example, when a copolymer is said to have a “propylene” content of 35 wt. % to 55 wt. %, it is understood that the mer unit in the copolymer is derived from propylene in the polymerization reaction and said derived units are present at 35 wt. % to 55 wt. %, based upon the weight of the copolymer. A copolymer can be terpolymers and the like.

As used herein, the terms “polymerization temperature” and “reactor temperature” are interchangeable.

In an extrusion process, “viscosity” is a measure of resistance to shearing flow. Shearing is the motion of a fluid, layer-by-layer, like a deck of cards. When polymers flow through straight tubes or channels, the polymers are sheared and resistance is expressed in terms of viscosity.

In the present disclosure, a “seal chamber” is an extension of a flash tank that is configured to maintain a volume of a slurry of polymer solids to maintain a seal and a pressure.

The term “fines” includes “polymer fines” and/or “catalyst fines” derived from the feed solid materials, and defines a portion of the entrained catalyst and polymer solids not removed by a separator or any removal/purification system. The fines are generally much smaller in size than the size of the polymer solids in the reactor slurry. The fines can include unreacted and/or under-reacted catalyst.

Olefin monomers for use in processes of the present disclosure may include C₂-C₈ alpha-olefins. For example, non-limiting examples of monomers include C₂ (ethylene) monomer and comonomers can include C₃-C₈ alpha-olefin comonomers, such as butene, pentene, hexene and octene.

Suitable diluents employed in such olefin polymerizations include C₃-C₅ saturated aliphatic hydrocarbons, such as C₃-C₅ saturated aliphatic hydrocarbons, such as C₃-C₄ saturated aliphatic hydrocarbons, such as propane, isobutane, n-butane, n-pentane, isopentane, or a combination thereof. In at least one embodiment, a diluent is isobutane. For example, the first reactor diluent, the re-slurry mixer diluent, and the second reactor diluent of the present disclosure can be the same, or different. Furthermore, excess recovered diluent from both the first and second reactor can be diverted to the recycle towers to be treated/purified, and then recycled back as recycle diluent to re-slurry mixer, reactor feed, catalyst and pump flushes that require low levels of monomer and other components.

### Examples of Polymerization Reactor Systems

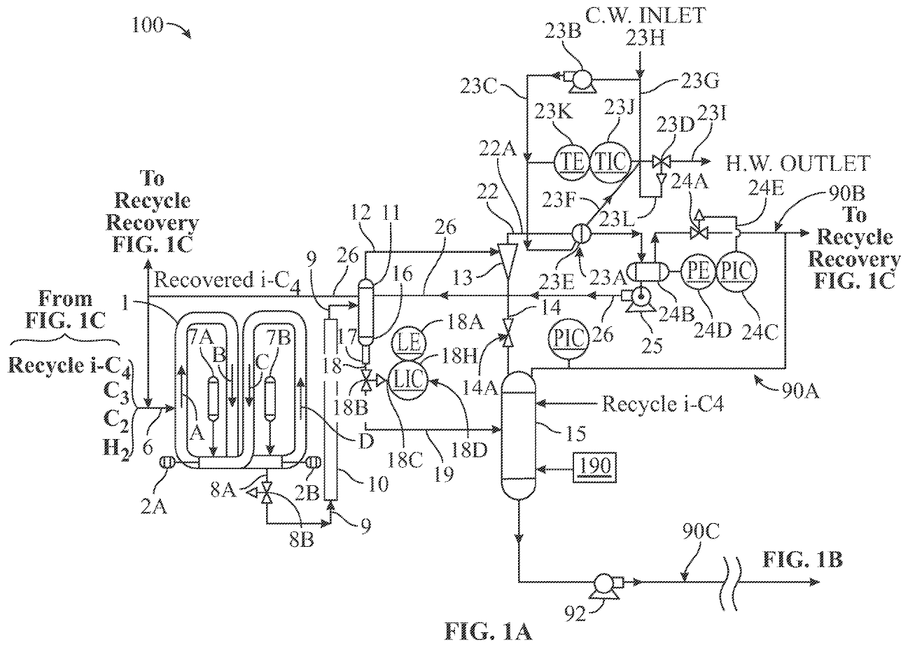

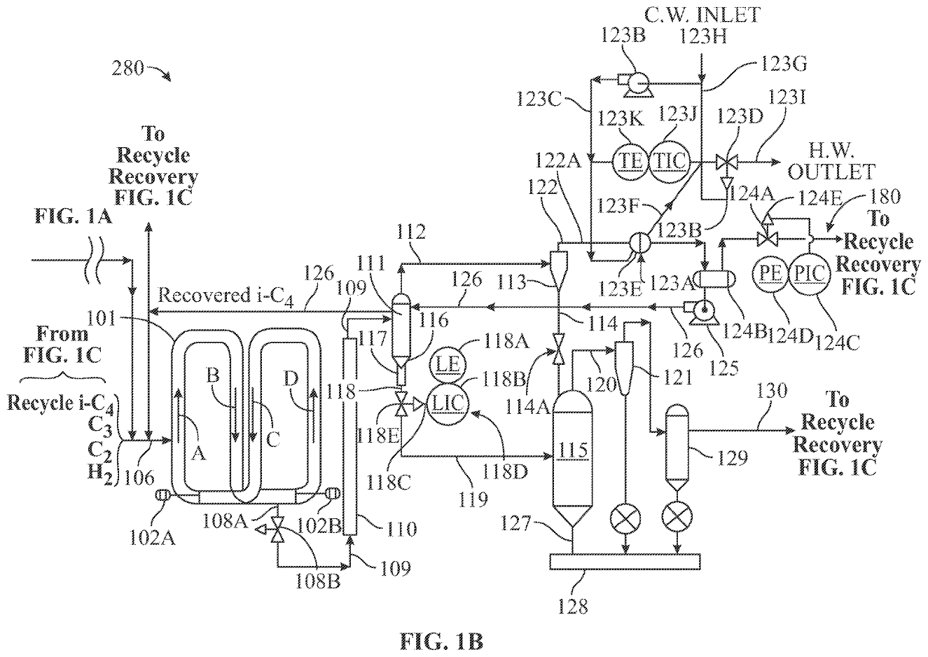

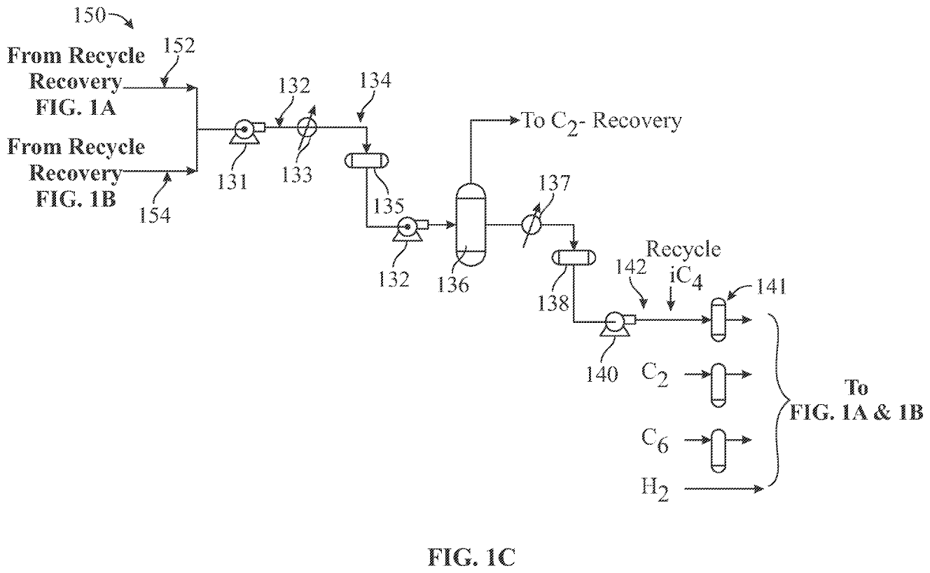

A further understanding of the present disclosure will be provided by referring to FIGS. 1A and 1B which collectively illustrate a polymerization reactor system comprising an embodiment of the present disclosure.

FIG. 1A is a diagram of an apparatus 100. FIG. 1B is a diagram of an apparatus 280. In the embodiment illustrated in FIG. 1A, apparatus 100 has a loop reactor 1 configured to perform polymerization. It will be understood that while the loop reactor 1 is illustrated with four vertical legs, the loop reactor 1 may be equipped with more legs, such as eight or more legs, such as between 8 and 20, such as between 8 and 16, such as with 12 legs. The polymerization slurry is directionally circulated throughout the loop reactor 1 as illustrated by arrows A-D by one or more pumps, such as axial flow pumps, 2A and 2B. In at least one embodiment, the loop reactor 1 is equipped with multiple pumps. Diluent, monomer, and/or comonomer, are introduced into the loop reactor 1 via conduit 6. The catalyst is added to the loop reactor 1 through one or more catalyst feed systems 7A and 7B. The catalyst can be introduced in a hydrocarbon diluent. In at least one embodiment, a monomer, a first reactor diluent, a catalyst, hydrogen, and optional comonomer are introduced to the loop reactor 1 to produce, under polymerization conditions, a first slurry of polymer solids including polymers having a molecular weight. Hydrogen is introduced in the loop reactor 1 at a first hydrogen concentration. The introduction of the monomer to the first reactor diluent, the catalyst, hydrogen, and optional comonomer can be performed at an internal reactor temperature of from about 50 °C to about 150 °C, such as about 50 °C to about 120 °C, and/or an internal reactor pressure of from about 200 psig to about 1000 psig, such as about 200 psig to about 800 psig.

Polymerization mixture (e.g., slurry) may be removed from the loop reactor 1 by continuous discharge through a discharge conduit 8A. It will be understood that the loop reactor 1 may be equipped with one or more discharge conduits 8A. It will be also understood that the discharge conduit(s) 8A may be operated in a continuous or discontinuous mode, such as a continuous mode. The discharge conduit 8A extends for a distance through a portion of the wall of the loop reactor 1 and into the circulating polymerization slurry. By extending for a distance into the polymerization slurry, the discharge conduit 8A may remove polymerization effluent from the circulating polymerization slurry over an area defined from near or adjacent the inside wall of the loop reactor 1 to a distance extending into the circulating polymerization slurry. Accordingly, a higher weight percentage of polymer solids may be formed within the discharge conduit 8A and ultimately removed from the loop reactor 1 than the weight percentage of polymer solids within the otherwise circulating polymerization mixture (e.g., slurry). A pressure control system operates in concert with the discharge conduit 8A.

The polymerization effluent passes from the discharge conduit 8A to the discharge valve 8B to a conduit 9 which is provided with a flash line heater 10 and into the first flash tank 11 (e.g., first HPFT) which separates vaporized liquid medium from polymer slurry/solids. In at least one embodiment, the first polymerization effluent is separated in the first flash tank 11 to vaporize from about 50% to about 100% of the first reactor diluent and provide a flash vapor including the first reactor diluent and unreacted monomer, and to provide a first concentrated polymer slurry. In further embodiments, hydrogen is present in the first concentrated polymer slurry exiting the first flash tank 11 at a second hydrogen concentration that is lower than the first hydrogen concentration. In at least one embodiment, the first hydrogen concentration is greater than the second hydrogen concentration. In further embodiments, little to no hydrogen is present in the first concentrated polymer slurry that is transferred from the first flash tank 11.

Vaporized liquid medium comprising diluent and unreacted monomers, hydrogen and other non-condensable gases like CO, O₂, CO₂ exit the first flash tank 11 via transfer conduit 12 through which it is passed into a separator 13 (e.g., a cyclone), which separates entrained polymer solids from the vapor. Polymer solids separated by the separator 13 are passed via conduit 14 through a control valve 14A designed to maintain a pressure seal below separator 13 to a re-slurry mixer 15.

Referring back to the first flash tank 11, the concentrated polymer solids/slurry in the bottom of the first flash tank 11 continuously settles by sliding along the straight line bottom surface 16 thereof into the seal chamber 17. Recycle diluent (of 141 (FIG. 1C)) can be introduced to the first concentrated polymer slurry (e.g., from a recycle diluent treater) to form a second concentrated polymer slurry in the re-slurry mixer 15, and further discharging the second concentrated polymer slurry from the re-slurry mixer 15 into a second loop reactor (as shown in FIG. 1B) via a pump 92. Additionally or alternatively, a second diluent can be introduced to the first concentrated polymer slurry from a diluent source 190. Control of the re-slurry mixer diluent flow into the reslurry mixer can be adjusted as required to maintain a pumpable slurry. In addition, the reslurry mixer pressure is controlled by venting via conduit 90A to the recycle recovery unit of FIG. 1C, as described in more detail below.

In the embodiment illustrated in FIG. 1A, polymer slurry/solids are continuously discharged from the seal chamber 17 into the re-slurry mixer 15. The length (1), diameter (d), and volume of the seal chamber 17 and the geometry of a seal chamber exit reducer 18 are chosen so as to provide a variable residence time and provide a continuous plug flow of concentrated polymer solids/slurry to minimize “dead” space and reduce plugging tendencies. The seal chamber 17 length should be sufficient to allow particle (polymer solids) level measurement and control.

Particle level measurement and control may be accomplished by a nuclear level indicating system 18D. The nuclear level indicating system 18D includes a nuclear radiating source (not shown) and receiver or level element 18A in signal communication with a level indicating controller 18B. In operation, the level element 18A generates a signal proportional to the particulate level in the seal chamber 17. The signal is conveyed to the level indicating controller 18B. In response to the signal and a preset value, the level indicating controller 18B sends a signal through a conduit (illustrated by broken line 18C) to a control valve 18E which selectively controls the discharge of polymer solids into a conduit 19.

Residence times of the concentrated polymer solid/slurry in the seal chamber 17 can be from about 5 seconds to about 10 minutes, such as from about 10 seconds to about 2 minutes, such as from about 15 seconds to about 45 seconds. The continuous plug flow of concentrated polymer solids/slurry forms a pressure seal wherein the concentrated polymer solids/slurry have a length to diameter ratio (l/d ratio) inside the seal chamber 17. The l/d ratio can be from about 1.5 to about 8, such as about 2 to about 6, such as about 2.2 to about 3. The seal chamber exit reducer 18 sides can be inclined, relative to the horizontal, 60 degrees-85 degrees, such as 65 degrees-80 degrees, such as 68 degrees-75 degrees. The seal chamber exit reducer 18 geometry is defined by substantially straight sides inclined at an angle to that of horizontal equal to or greater than the angle of slide of the concentrated polymer slurry/solids and communicates the concentrated polymer solid/slurry to transfer conduit 19 which communicates with a feed inlet of the re-slurry mixer 15. A pump can be provided for conveying the polymer slurry from the re-slurry mixer 15 to the second loop reactor. The pressure of the re-slurry mixer 15 can be maintained at equal to or less than the pressure of the first flash tank 11. The re-slurry mixer 15 is vented to the recycle system (via conduit 90A) for pressure control.

Referring now to the separator 13, the major portion of the liquid medium in the polymerization effluent may be been taken to separator 13 as vapor where the larger polymer solids/catalyst particles are removed. The vapor, after having a portion of the entrained catalyst and polymer solids removed, is passed via conduit 22 through a heat exchanger system 23A where the vapor at a pressure from about 75 psig to about 250 psig is condensed by indirect heat exchange with a heat exchange fluid such as to eliminate the need for compression. The portion of the entrained catalyst and polymer solids not removed by the separator 13 are substantially smaller in size and may be referred to as “fines”. These fines may include unreacted and/or under-reacted catalyst.

The heat exchanger system 23A includes a heat exchanger 23E and a tempered water circulating pump 23B connected to the heat exchanger 23E by conduit 23C. A tempered water temperature control valve 23D is connected to the heat exchanger 23E and water circulating pump 23B by conduits 23F and 23G, respectively. Cooling water from a cooling water source (not shown) is conveyed via a cooling water conduit 23H into the conduit 23G between the control valve 23D and the water circulating pump 23B. A temperature indicating controller (TIC) 23J is connected between the control valve 23D and the conduit 23C. Between the TIC 23J and the conduit 23C resides a temperature element 23K.

The heat exchanger system 23A operates to control the amount of vapor condensed in the heat exchanger 23E. The control can be accomplished by controlling the flow of cooling water introduced into the conduit 23G from the cooling water conduit 23H by exhausting heated water formed in the heat exchanger 23E. The heated water from the heat exchanger 23E is conveyed to the control valve 23D via the conduit 23F. The heated water exits the control valve 23D via the conduit 23I.

Furthermore, a cooling water from the cooling water conduit 23H entering the conduit 23G mixes with a circulating tempered water in the conduit 23G, the mixture thereof enters the water circulating pump 23B. The water exiting the water circulating pump 23B enters the conduit 23C, a portion of which contacts the temperature element 23K, in route to the heat exchanger 23E. The temperature element 23K generates a signal proportional to the temperature in conduit 23C. The signal is conveyed to the TIC 23J. In response to the signal and a preset temperature value, the TIC 23J sends a signal through a signal conduit (illustrated by the line 23L) to the control valve 23D which selectively controls the volume of heated water exiting the system through the conduit 23I.

The condensed liquid medium formed at the heat exchanger 23E includes diluent, unreacted/under-reacted catalyst, polymer solids, and unreacted monomers. The condensed liquid medium is then passed to an accumulator 24B via a conduit 22A.

Purging of the catalyst poison that was added to the first reactor effluent is accomplished by the vapor purge rate from the accumulator. This can be accomplished by measuring the concentration of the catalyst poison in the purge stream. This can also be accomplished by monitoring the reactor catalyst activity. The amount of vapor condensed in the heat exchanger 23E is controlled and sufficient vapor pressure in the accumulator 24B is maintained. Thus, a pressure control valve 24A can maintain sufficient back pressure on the accumulator 24B. By maintaining a sufficient back pressure on the accumulator 24B, a proper operating pressure is maintained in the first flash tank 11. The pressure control valve 24A is actuated by a pressure indicating controller 24C in concert with a pressure element 24D. The pressure element 24D is in sensing communication with the accumulator 24B. The pressure element 24D generates a signal proportional to the pressure in the accumulator 24B. In response to the signal and a preset pressure value, the pressure indicating controller 24C sends a signal through a signal conduit (illustrated by the broken line 24E) to the control valve 24A which selectively controls the back pressure on the accumulator 24B.

A pump 25 is provided for conveying the condensed liquid medium from the accumulator 24B back to the polymerization zone by a conduit 26. Thus, the unreacted/under-reacted catalyst and polymer solids not removed by the separator 13 are returned for further polymerization to the loop reactor 1 or sent via conduit 26 to recycle recovery unit of FIG. 1C, as described in more detail below.

In at least one embodiment, the second concentrated polymer slurry formed in the re-slurry mixer 15 is transferred via pump 92 from the re-slurry mixer 15 to a second loop reactor 101 (FIG. 1B) for further processing.

In the embodiment illustrated in FIG. 1B, a second polymerization process is carried out in a second loop reactor 101. Loop reactor 101 may be used to form substantially the same type of polymer as was formed in loop reactor 1 or loop reactor 101 may be used to form a different type of polymer as was formed in loop reactor 1 (e.g., to form a bimodal polymer product). Additional monomer and comonomer are introduced to the second loop reactor 101 in a second reactor diluent (combination of second reactor recovered diluent and recycled diluent) to produce, under polymerization conditions, a second slurry of polymer including copolymers having a second molecular weight. The second slurry of polymer solids has a third hydrogen concentration, which is significantly lower than the first hydrogen concentration.

It will be understood that while the second loop reactor 101 is illustrated with four vertical legs, the second loop reactor 101 may be equipped with more legs, such as eight or more legs, such as between 8 and 20, such as between 8 and 16, such as with 12 legs. The polymerization slurry is directionally circulated throughout the second loop reactor 101 as illustrated by arrows A-D by one or more pumps, such as axial flow pumps, 2A and 2B. In at least one embodiment, the second loop reactor 101 is equipped with multiple pumps.

Diluent (both recovered from second loop reactor 101 and recycled diluent), comonomer and monomer are introduced into the second loop reactor 101 via conduit 106.

A co-catalyst can be added directly to the second loop reactor 101. The co-catalyst can be introduced in a hydrocarbon diluent. In at least one embodiment, the second reactor diluent is a C₃-C₅ saturated aliphatic hydrocarbon (e.g., isobutane). In further embodiments, the first hydrogen concentration is greater than the second hydrogen concentration, such as little to no hydrogen is present in the loop reactor 101.

Computer control of residence time and solids concentration in the second loop is used to achieve the balance of the first reactor solids with the second reactor solids for a desired polymer product.

Polymerization slurry may be removed from the second loop reactor 101 by continuous discharge through a discharge conduit 108A. It will be understood that the second loop reactor 101 may be equipped with one or more discharge conduits 108A. It will be also understood that the discharge conduit(s) 108A may be operated in a continuous or discontinuous mode, such as a continuous mode. The discharge conduit 108A extends for a distance through a portion of the wall of the second loop reactor 101 and into the circulating polymerization slurry. By extending for a distance into the polymerization slurry, the discharge conduit 108A may remove polymerization effluent from the circulating polymerization slurry over an area defined from near or adjacent the inside wall of the second loop reactor 101 to a distance extending into the circulating polymerization slurry. Thus, a higher weight percentage of polymer solids may be formed within the discharge conduit 108A and ultimately removed from the second loop reactor 101 than the weight percentage of polymer solids within the otherwise circulating polymerization slurry. A pressure control system (not shown in FIG. 1B) operates in concert with the discharge conduit 108A.

The polymerization effluent passes from the discharge conduit 108A to the discharge valve 108B to a conduit 109 which is provided with a line heater 110 and into the second flash tank 111 (e.g., second HPFT) which separates vaporized liquid medium from polymer slurry/solids. A catalyst poison is added which can include O₂, CO₂, and CO, as described in U.S. Pat. No. 9,637,570, incorporated by reference herein for that description.

Vaporized liquid medium comprising diluent and unreacted monomers, hydrogen and other non-condensables exit the second flash tank 111 via transfer conduit 112 through which it is passed into a separator 113, such as a cyclone, which separates entrained polymer solids from the vapor. Polymer solids separated by the separator 113 are passed via conduit 114 through a control valve 114A designed to maintain a pressure seal below separator 113 to a lower pressure third flash tank 115 (e.g., LPFT). In at least one embodiment, the third flash tank 115 (e.g., LPFT) is operated at a pressure of from about 0.05 psig to about 50 psig, such as at about 20 psig.

Referring back to the second flash tank 111, the concentrated polymer solids/slurry in the bottom of the second flash tank 111 continuously settles by sliding along the straight line in 5 bottom surface 116 thereof into the seal chamber 117. A polymer solids/slurry level is maintained in the seal chamber 117 to eliminate plugging tendencies in second flash tank 111 and to form a pressure seal so that the second flash tank 111 can operate at a substantially higher pressure than the third flash tank 115. Polymer slurry/solids are continuously discharged from the seal chamber 117 into the lower pressure third flash tank 115. The length (l), diameter (d), and volume of the seal chamber 117 and the geometry of the seal chamber exit reducer 118 are chosen so as to provide a variable residence time and provide a continuous plug flow of concentrated polymer solids/slurry to minimize “dead” space and reduce plugging tendencies. The seal chamber 117 length should be sufficient to allow particle (polymer solids) level measurement and control.

Particle level measurement and control may be accomplished by a nuclear level indicating system 118D. The nuclear level indicating system 118D includes a nuclear radiating source (not shown) and receiver or level element 118A in signal communication with a level indicating controller 181B. In operation, the level element 118A generates a signal proportional to the particulate level in the seal chamber 117. The signal is conveyed to the level indicating controller 118B. In response to the signal and a preset value, the level indicating controller 118B sends a signal through a conduit (illustrated by broken line 118C) to a control valve 118E which selectively controls the discharge of polymer solids into a second transfer conduit 119.

Suitable residence times of the concentrated polymer solid/slurry in the seal chamber 117 are from about 5 seconds to about 10 minutes, such as from about 10 seconds to about 2 minutes, such as from about 15 seconds to about 45 seconds. The continuous plug flow of concentrated polymer solids/slurry forms a pressure seal wherein the concentrated polymer solids/slurry have an l/d ratio inside the seal chamber 117 which is about 1.5 to about 8, such as about 2 to about 6, such as about 2.2 to about 3. The seal chamber exit reducer 118 sides are inclined, relative to the horizontal, 60 degrees-85 degrees, such as 65 degrees-80 degrees, such as 68 degrees-75 degrees. The seal chamber exit reducer 118 geometry is defined by substantially straight sides inclined at an angle to that of horizontal equal to or greater than the angle of slide of the concentrated polymer slurry/solids and communicates the concentrated polymer solid/slurry to a second transfer conduit 119 which communicates with a feed inlet of the third flash tank 115. In the third flash tank 115, substantially all of any remaining inert diluent and unreacted monomer in the concentrated polymerization effluent is vaporized and taken overhead via conduit 120 to a secondary separator 121.

Referring now to the separator 113, the major portion of the liquid medium in the polymerization effluent may be been taken to separator 113 as vapor where the larger polymer solids/catalyst particles are removed. The vapor after having a portion of the entrained catalyst and polymer solids removed is passed via conduit 122 through a heat exchanger system 123A wherein the vapor at a pressure from about 75 psig to about 250 psig is condensed by indirect heat exchange with a heat exchange fluid such as to eliminate the need for compression. The portion of the entrained catalyst and polymer solids not removed by the separator 113 are smaller in size and may be referred to as “fines”. These fines may include unreacted and/or under-reacted catalyst.

The heat exchanger system 123A includes a heat exchanger 123E and a tempered water circulating pump 123B connected to the heat exchanger 123E by conduit 123C. A tempered water temperature control valve 123D is connected to the heat exchanger 123E and water circulating pump 123B by conduits 123F and 123G, respectively. Cooling water from a cooling water source (not shown) is conveyed via a cooling water conduit 123H into the conduit 123G between the control valve 123D and the water circulating pump 123B. A temperature indicating controller (TIC) 123J is connected between the control valve 123D and the conduit 123C. Between the TIC 123J and the conduit 123C resides a temperature element 123K.

The heat exchanger system 123 A operates to control the amount of vapor condensed in the heat exchanger 123E. The control can be accomplished by controlling the flow of cooling water introduced into the conduit 123G from the conduit 123H by exhausting heated water formed in the heat exchanger 123E. The heated water from the heat exchanger 123E is conveyed to the control valve 123D via the conduit 123F. The heated water exits the control valve 123D via the conduit 123I.

Furthermore, cooling water from the conduit 123H entering the conduit 123G mixes with circulating tempered water in the conduit 123G, the mixture thereof enters the pump 123B. The water exiting the pump 123B enters the conduit 123C, a portion of which contacts the temperature element 123K, in route to the heat exchanger 123E. The temperature element 123K generates a signal proportional to the temperature in conduit 123C. The signal is conveyed to the TIC 123J. In response to the signal and a preset temperature value, the TIC 123J sends a signal through a signal conduit (illustrated by the broken line 123L) to the control valve 123D which selectively controls the volume of heated water exiting the system through the conduit 123I.

The condensed liquid medium formed at the heat exchanger 123E includes diluent, unreacted/under-reacted catalyst, polymer solids and unreacted monomers. The condensed liquid medium is then passed to an accumulator 124B via a conduit 122A.

Purging of the catalyst poison kill agent (e.g., CO, CO₂, or O₂) that was added to the second reactor effluent is accomplished by the vapor purge rate from the accumulator 124B. This can be accomplished by measuring the concentration of the catalyst poison in the purge stream. This can also be accomplished by monitoring the reactor catalyst activity. The amount of vapor condensed in the heat exchanger 123E is controlled and sufficient vapor pressure in the accumulator 124B is maintained. Thus, a pressure control valve 124A can maintain sufficient back pressure on the accumulator 124B. By maintaining a sufficient back pressure on the accumulator 124B, a proper operating pressure is maintained in the second flash tank 111. The pressure control valve 124A is actuated by a pressure indicating controller 124C in concert with a pressure element 124D. The pressure element 124D is in sensing communication with the accumulator 124B. The pressure element 124D generates a signal proportional to the pressure in the accumulator 124B. In response to the signal and a preset pressure value, the pressure indicating controller 124C sends a signal through a signal conduit (illustrated by the broken line 124E) to the pressure control valve 124A which selectively controls the back pressure on the accumulator 124B. An accumulator effluent of accumulator 124B can be transferred via conduit 180 to recycle recovery unit of FIG. 1C, as described in more detail below.

A pump 125 is provided for conveying the condensed liquid medium from the accumulator 124B back to the polymerization zone or to the recycle recovery unit (of FIG. 1C) by a conduit 126. Thus, the unreacted/under-reacted catalyst and polymer solids not removed by the cyclone 113 are returned for further polymerization to the second loop reactor 101, providing control of the use of recovered diluent versus the recycled diluent.

The polymer solids in the lower pressure third flash tank 115 are passed via a conduit 127 to a finishing device 128. Finishing device 128 can be a pellet mill, a rolling mill, a briquetter, tableter, or combination thereof, e.g., as described in more detail below. The vapor exiting the secondary separator 121, after filtration in a filter unit 129, is passed by a conduit 130 to the recycle recovery unit (of FIG. 1C). A bottoms portion containing polymer solid/slurry from secondary separator 121 and/or filter unit 129 may likewise be passed via a conduit to finishing device 128.

FIG. 1C illustrates a recycle recovery unit 150. Recycle recovery unit 150 includes feed line 152 and feed line 154. Feed line 152 includes one or more of the contents of conduits 26, 90A, or 90 B of FIG. 1A. Feed line 154 includes one or more of the contents of conduits 126, 130, or 180 of FIG. 1B. Recycle recovery unit 150 further includes a compressor 131 and the compressed vapors are passed through a conduit 132 to a condenser 133 where vapor is condensed. The condensate is passed through conduit 134 to storage vessel 135. The condensed liquid medium in the storage vessel 135 can be vented overhead for removal of light-end contaminants. The inert diluent can be distilled in unit 136 for removal of light-ends and then a vapor side draw of degassed isobutane is condensed by heat exchanger 137 and stored in vessel 138. The recycled isobutane can then be pumped via a pump 140 through conduit 142 to treater 141 to conduits to the first reactor 1 and to the re-slurry mixer (of FIG. 1A) and to the second loop reactor 101 (of FIG. 1B).

### Pellet Mill

In some embodiments, a finishing device (such as finishing device 128 of FIG. 1B) is a pellet mill.

### Vertical Ring Pellet Mill

In some embodiments, a pellet mill is a vertical ring pellet mill.

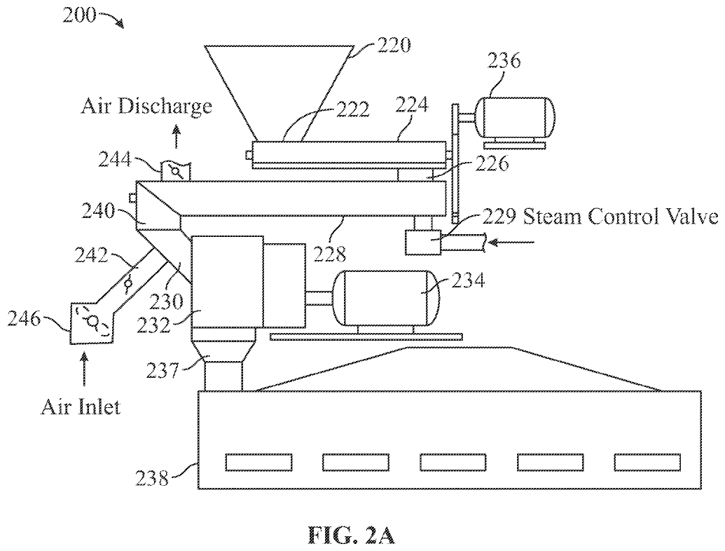

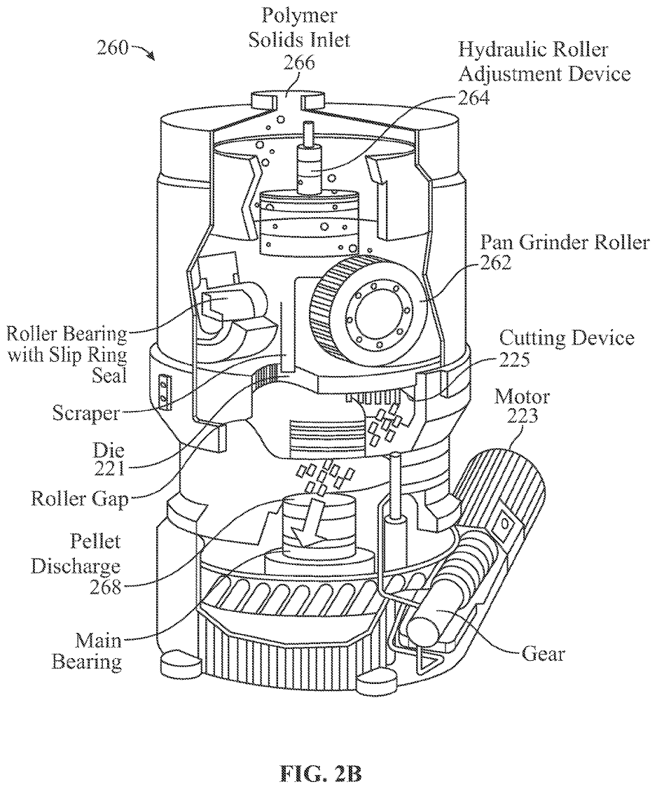

FIG. 2A is a pellet mill, according to an embodiment. As shown in FIG. 2A, pellet mill 200 includes feed bin 220. Polymer solids (e.g., of conduit 127 of FIG. 1B) are introduced into feed bin 220 and are gravity fed through bin outlet 222 into the feed conveyor 224 driven by feed conveyor motor 236. From the feed conveyor outlet 226, the polymer solids enter the conditioner vessel 228 where they are subjected to mixing (optionally with one or more additives) by injection of steam from steam valve 229 into conditioner vessel 228. Although steam might be used in some embodiments, in alternative embodiments steam is not used. The temperature and moisture content of the polymer solids can be increased in the conditioner vessel 228. This leads to a reduction in shear strength of the polymer solids which, if not carried too far, improves pelletizing behavior. After a predetermined conditioning time, the polymer solids are fed from conditioner vessel 228 through conditioner outlet 230 into pelletizing mill 232 which is driven by drive motor 234. The polymer solids are forced through apertures in a pelletizing die (not shown) within the pelletizing mill to form compact and durable pellets. These pellets are fed through connector duct 237 into pellet cooler 238 where they are cooled prior to removal. In some embodiments, cooling is not performed.

Dwell time in the conditioner is controlled and depends on the particular polymer solids being pelletized; and to achieve the proper shear strength reduction for pelletizing, which is determined by the particle size and chemical structure of the polymer solids. Generally, more finely ground particulate material involves a shorter conditioning time than does coarsely ground or large particle polymer solids. The longer conditioner dwell time required by coarse particles can benefit from a larger conditioner in order to maintain operation of the pelletizing mill at its design capacity. The temperature and moisture content of the conditioner atmosphere interact with the particles being conditioned to form temperature and moisture gradients between the outer surfaces and the centers of the particles. The rate of conditioning, then, is ultimately determined by the thermal and moisture conductivity of the particulate material. In order to drive the conditioning reaction at a practical rate, it may be beneficial to operate the conditioner with an atmosphere having a temperature and moisture content which are well above the optimum temperature and moisture content for the conditioned material. This results in particles entering the pelletizing mill with surface temperatures and surface moisture contents which may be excessive, thereby producing shear strength less than that required for optimum pelletizing behavior and resulting in periodic plugging of the pelletizing die.

This problem can be avoided if the polymer solids are smaller sized to be pelletized and, thereby, maintaining a short dwell time in the conditioner and a minimal thermal and moisture gradient from the surface to the center of the particles.

Alternatively, pelletizing large particles while avoiding the problem of plugging of the pelletizing die if an air inlet and blower 246 is utilized, as shown in FIG. 2A, to avoid pelletizing die plugging and the consequent emptying and purging of the conditioner—another cause of costly down time.

Upon completion of the appropriate dwell time within the conditioner, the polymer solids, having excess moisture/diluent at its surface and excess temperature at its surface, falls through flash dryer 240 where it is exposed to a countercurrent of relatively cool dry air provided by blower 246 through air inlet 242. In some embodiments, flash dryer 240 is absent/not used. This dryer can also use heated air, if desired, which causes flash evaporation of surface moisture which is carried away through air outlet 244, and which is accompanied by an attendant temperature reduction at the surface. The central, properly conditioned, portion of the particles is not affected by this flash drying because diffusion of both moisture and temperature from the center of the particles is slow enough that it cannot occur during the rapid flash drying operation. From flash dryer 240 the particles pass through outlet 230 and enter pelletizing mill 232 where they are pelletized in the pelletizing die (which is oriented vertically) without plugging. After forming, the pellets are fed through connector duct 237 into the pellet cooler 238 where they are cooled prior to removal.

### Horizontal Ring Pellet Mill

In some embodiments, a pellet mill is a horizontal ring pellet mill.

FIG. 2B is a pellet mill, according to an embodiment. The polymer solids are converted to pellets using a horizontal ring pellet mill 260, which may also be referred to as a die press machine or pellet press or pelletizing machine.

As shown in FIG. 2B, the horizontal ring pellet mill 260 has a horizontal fixed die 221, which can achieve high throughput. As exemplified in FIG. 2B, four horizontal rollers 262 are arranged in a radial direction around a vertical shaft, like spokes of a wheel, and are attached to the shaft (although it is noted that more or fewer rollers can be utilized in accordance with various embodiments). A motor 223, coupled to a gear box at the base of the machine, provides the rotational force to the shaft, through the gear box, to rotate the shaft at about 70 to 80 rpm. In some embodiments, the gear box includes a worm-gear that provides driving force. The roller assembly is attached to a computer controlled hydraulic jack 264, which maintains downward pressure on the rollers. The downward pressure is controlled based on data input into a control computer (not shown). A cutting tool (e.g., a series of knives or cutters) 225 are attached to the vertical shaft underneath the die 221. Cutters 225 cut the material off at a fixed length as the material is extruded through die 221.

In operation, polymer solids are gravity fed into the horizontal ring pellet mill 260 via a polymer solids inlet 266 above the die. In some embodiments, the raw material is fed into the hopper using a vibratory feeder. As the vertical shaft of the horizontal ring pellet mill 260 is turned, the rollers 262 pass over fixed die 221 and press the polymer solids through the die. When the mixture is pressed into die 221, heat is generated by the friction of squeezing the material at extreme compaction ratios. Steam is also admitted into the press to further heat die 221. As the polymer solids come in contact with the heated die, the polymer solids form a layer. As each layer pushes out of the die, a pellet is created.

As the polymer solids are pressed through the die, the knives or cutters 225 pass underneath the die 221, cutting off a length of extruded polymer solids, thereby forming pellets. The knives or cutters 225 are attached to the same shaft as the rollers 262 which extrude the material through the die 221. The cutting tool 225 are at a fixed operating angle, or dwell angle, behind the rollers 262, and shear off the pellet at a precise length. The length of the pellet coincides with finished granular polymer product. Discharge wiper blades move the material out of the machine and on to the cooler.

FIG. 2C is a detailed depiction of the pelleting and cutting portion of the horizontal ring pellet mill 260 of FIG. 2B. As shown, the polymer solids (as a layer) rests on die 221. Die 221 rotates such that the polymer solids are presented to grinder roller 262. Roller 262 forces the polymer solids through the die. The heat generated during the pelleting process can help agglomerate the pieces of polymer solids together, then the polymer solids are extruded through the die and cut off into substantially equal size pellets by cutting tool 225. Due to the known rate of extrusion, the cutting tool can be placed such that a desired length pellet is achieved. In at least embodiment, in place of the straight roller 262, a conical roller may be used.

A pellet discharge chute 268 can be arranged beneath the cutting tool 225 to catch the extruded pellets. A cooler can be used to reduce the temperature of the pellets.

In contrast to prior art ring-die configured machines, a horizontal die press machine has less wear, produces less heat, and consumes less energy. This die press, which typically has a relatively large mass, does not move. Thus, the rotational speed of the rollers can be relatively slow. For example, for a given die size, an approximately 40% increase in throughput has been achieved with an approximately 50% reduction in energy usage. This die press machine can also produce a more uniform and consistent pellet. An additional advantage of horizontal ring pellet mill 260 is that it does not utilize mechanical shear pins to limit the pressure of the rollers on the die. Instead, hydraulic pressure applied to the rollers can be monitored with sensing devices, and can be controlled in one embodiment by a programmable logic controller (PLC).

Horizontal ring pellet mill 260 provides an ability to influence the density of the pellets, and therefore the density of the finished product, by increasing or decreasing the hydraulic pressure applied to the rollers. Tolerances can be achieved using this configuration improving the uniformity of the resultant pellets. Additionally, depending on the dimensions of the die used, the so-called die specifications, the density of the finished product can also be changed. Forcing the material through the die promotes a chemical change in the materials by the application of heat and friction. Different die specifications change the compression of the polymer solids and the amount of time that the polymer solids are compressed, known as the dwell time. Horizontal ring pellet mill 260 provides an added advantage in that the die can be changed in a relatively short duration of time compared to changing the die of a vertical die pellet mill.

Pellets of the present disclosure may be formed at temperatures of less than about 110 °C, such as about 70 °C to about 110 °C, such as about 80 °C to about 100 °C. Pressures used for forming pellets may be up to about 25,000 pounds per square inch. In some embodiments, pellets can be formed below 500 psi, and processes of the present disclosure allow for the creation of high stability pellets below 10,000 psi, such as about 5,000 psi to about 10,000 psi.

In some embodiments, if processing at the preferred lower temperatures doesn't yield a sufficiently compacted/stable pellet, one may have to process at higher temperatures (including up to and surpassing melting point of the polymer) in order to achieve sintering in the mill; or, alternatively, the pre-processed pellets can be passed from the mill to a sintering device for further heat/compaction to be applied. This is not necessarily preferred, but may be required for certain polymer solids that may not agglomerate sufficiently in the mill. Such temperatures for sintering can include those within the range of 80 °C to 150 °C. Further, it is anticipated that pressure applied to the polymer during the higher-temperature sintering should be sufficient so as to avoid melting or tackiness in the equipment.

### Briquetter

In some embodiments, a finishing device (such as finishing device 128 of FIG. 1B) is a briquetter. In some embodiments, a briquetter is a single stroke linear briquetter or dual roll briquetter.

### Single Stroke Linear Briquetter

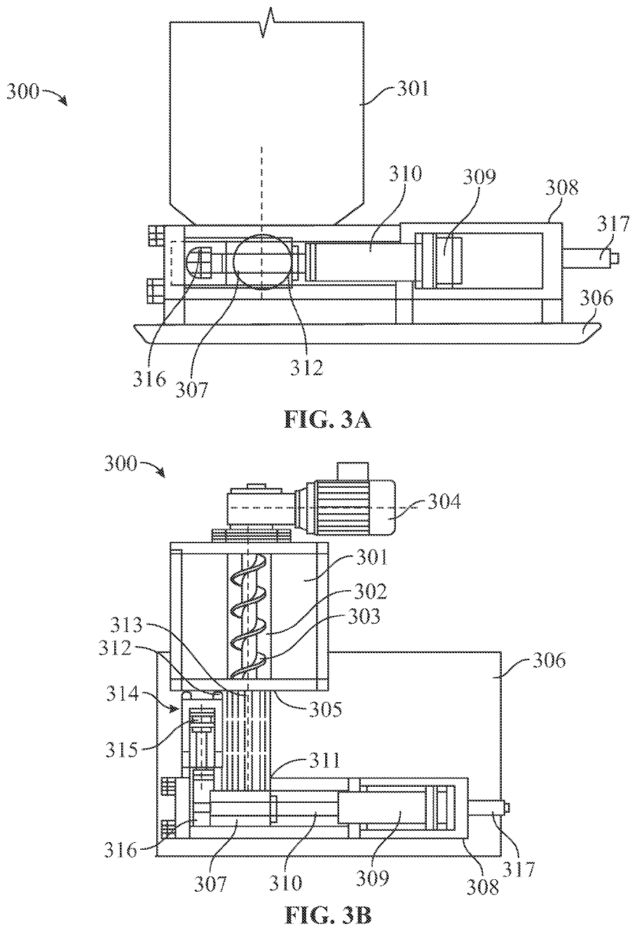

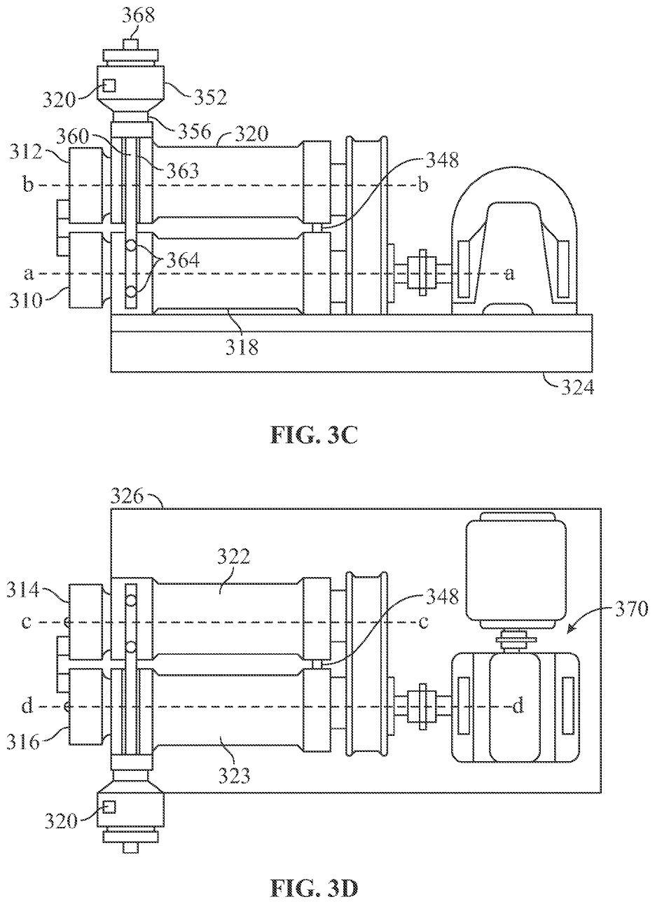

FIGS. 3A and 3B illustrate a briquetter 300, according to an embodiment. Briquetter 300 has a container 301, in the form of a funnel for charging polymer solids (and additive(s)) to be pressed and that opens out into a tank 302. A charging screw 303 is mounted in the tank 302 and is driven by a screw driver 304. This screw driver comprises gearing and an electric motor. In the region of or near the charging screw 303, the tank 302 has a container opening 305. This charging apparatus is thus in the form of an independent module.

In addition, the apparatus has a briquette press, which is installed on a base plate 306 and includes a shaping chamber 307 and a cylinder piston unit 308 attached to the shaping chamber 307, the piston 309 of the cylinder piston unit has a press ram 310. The piston 309 is driven by a pneumatic or hydraulic driving system (not represented). The press ram 310, in this case, is moved backwards and forwards in the shaping chamber 307 to make the briquettes. The shaping chamber 307 has a lateral supply opening 311. Between the container opening 305 and the supply opening 311 there is a pipe 312 with screen openings, which are in the form of slots, such as the slot 313. The pipe 312 can be secured to the tank 302 to be easily interchangeable. The container 301 with the charging screw 303 and the screw driver 304 is disposed to be displaceable in the longitudinal direction of the screw relative to the shaping chamber 307 and to be fixable in position so that different types and lengths of pipes 312 can be used.

In addition, the apparatus has a closure slide apparatus 314, which comprises a cylinder piston unit and a closure slide 316, which is connected to the piston 315 of the cylinder piston unit and closes or respectively opens the end of the shaping chamber 307 situated opposite the press ram 310. The driver of the piston 315 is pneumatic or hydraulic.

The apparatus also has a displacement pickup 317, which is secured to the cylinder piston unit 308. A variable pressing operation is possible with this displacement pickup. The speed of the press ram is variable in a forward direction and can consequently be adapted to an optimum pressing result. This variable speed can, for example, be achieved with regulatable pumps at a constant speed or with constant pumps with preferably frequency regulated drive motors.

The charging apparatus 301-304, which is formed as an independent module, is mounted on the briquette press 306-317, to be easily interchangeable.

Once the container 301 is charged with polymer solids, the polymer solids to be pressed are forced into the pipe 312 and into the shaping chamber 307 by the charging screw 303 with the closure slide 316 closed. At the same time, the moisture/diluent and gases of the polymer solids are separated from the rest of the polymer solids to be pressed through the screw pressure. The moisture/diluent and gases are discharged via the slots 313 of the pipe 312 and are collected and disposed of in a manner not shown. The screw driver 304 has a current consumer, which responds before the charging screw 303 becomes blocked and stops the screw driver 304. The dried polymer solids to be pressed in the shaping chamber 307 are then pressed by the press ram to form briquettes, which are forced out once the closure slide 316 is open. With some types of polymer solids to be pressed, it is advantageous if the pressure is removed from the press ram after the first pressing operation and is then applied once again. This means that it is easier for the residual air or moisture in the briquette, compressed at various pressing pressures, to dissipate.

### Dual Roll Briquetter

In some embodiments, a briquetter is dual roll briquetter. In some embodiments, a dual roll briquetter is a DH500 briquetter available from KOMAREK™ of Wood Dale, Illinois. A DH 500 briquetter has a roll diameter of about 28 inches, roll width of about 9 inches to about 20 inches, a maximum roll separating force of about 330 ton-force, a roll drive of about 250 horse power, a feeder drive of about 30 horse power, a throughput range of about 20 t/h to about 60 t/h, and a machine weight of about 73,000 lbs.

In some embodiments, a briquetter has a pair of elongated shafts for rotating briquette-forming rolls, the shafts being substantially parallel.

In the embodiment depicted in FIG. 3C, the elongated shafts the longitudinal axes of which are represented by lines a--a and b--b, are substantially parallel, vertically spaced and each mounted in a one-piece bearing housing. The shafts a--a and b--b rotate a pair of cooperating, briquette-forming rolls 310 and 312 which are mounted at one end of the shafts a--a and b--b projecting beyond the end of the respective bearing housings.

It may be preferred for some types of operations that the elongated parallel shafts of this embodiment be horizontally spaced, as depicted in FIG. 3D. In this arrangement, the shafts c--c and d--d rotate a pair of briquette-forming rolls 314 and 316. As the description of the embodiment where the shafts are each mounted in a one-piece bearing housing is substantially the same whether the shafts are vertically or horizontally spaced, only a description of the vertically spaced arrangement will be provided unless differences exist.

In accordance with the invention, the press provides a pair of bearing housings for rotatably mounting the shafts, one of the bearing housings being rigidly mounted. In the embodiment depicted in FIG. 3C, the bearing housings 318 and 320 are in vertical relationship with the rigidly mounted bearing housing 318 being the lower one. The shaft a--a is rotatably carried by the rigidly mounted bearing housing 318 and one end of the shaft a--a extends beyond the end of the bearing housing 318 and carries the briquette-forming roll 310. The shaft b--b is rotatably carried by the pivotally mounted bearing housing 320 and one end of the shaft b--b extends beyond the bearing housing 320 to carry the roll 312.

In some embodiments, the shafts be in horizontal relationship (FIG. 3D), one of the bearing housing 322 is rigidly mounted. The rigidly mounted bearing housings 318 and 322 can be mounted on a base 324 and 326, respectively.

In accordance with the invention, means for pivoting the other bearing housing to the rigidly mounted bearing housing for motion in the plane of the shafts is provided. The pivoting means is located substantially midway between the axes of the shafts.

For example, where the bearing housing for each shaft is in one piece (FIG. 3C), the pivot 348 may be any appropriate device which will permit free movement of the pivotally mounted bearing housing 320 and which will support that bearing housing. As depicted, the pivot is a cylindrical bar, the axis of which is normal to the plane of the shaft axes.

It may be preferred that the pivot 348 be demountable for detaching the pivotally mounted bearing housing 320 from the rigidly mounted bearing housing 318 and removing the former from the press. This location of the pivot 348 midway between the shafts a--a and b--b permitting rotation of the pivotally mounted bearing housings 320 in the same plane as the shafts a--a and b--b serves, to reduce deviation of the roll 312 from the position where the lines tangent to the peripheries of both rolls are in parallel relation and the lines of radius of the rolls are in planes normal to the plane containing the axes of the rolls.

The rolls used are biased together in substantially tangential contact. In some embodiments, the biasing includes a hydraulic to hydraulicly provide an adjustable, constant force. In order to prevent damage to the press, it may also be preferred that the hydraulic includes an automatic release mechanism, such as a pressure-actuating by-pass valve, which releases the constant biasing force in the event an overload of polymer solids is introduced between the rolls. It may be preferred that the hydraulic comprises a plurality of hydraulic cylinders.

Hydraulic cylinder 352 provides the force by means of hollow piston rod 356. Connecting rod 360 is also used. The connecting rod 360 is attached at one end, by any suitable connector such as bolts 364, to each side, respectively, of the rigidly mounted bearing housing 318. The connecting rod 360 slidably passes through slot 63 in each side of the pivotally mounted bearing housing and slidably pass through the hollow piston rod 356. The other end 368 of the connecting rod 360 passes through the hydraulic cylinder 352 and is attached to and supports the hydraulic cylinder 352 on the side of the pivotally mounted bearing housing 320 remote from the rigidly mounted bearing housing 318. The force of the hydraulic cylinder 352 is exerted by piston rod 356 on the pivotally mounted bearing housing 320 and, in an opposite direction, on the rigidly mounted bearing housing 318 by connecting rod 360 thereby tending to bring the rolls 310 and 312 into substantially tangential contact.

A connecting rod is provided in order to prevent relative lateral movement between the shafts and the pivot means, besides permitting pivotal rotation of the pivotally mounted bearing housing, tends to prevent relative longitudinal movement between shafts, thereby insuring continual complementary alignment of the rotating rolls. The hydraulic cylinders in each embodiment provide a constant hydraulic force biasing the rotating rolls into tangential contact and tending to prevent variations in pressure between the rotating rolls.

It may preferred to rotate the elongated shafts. For example, the rotator 370 acts on the elongated shafts a--a and b--b at their ends remote from the rotating rolls 310 and 312. As depicted, the rotator may be any suitable motor, speed reducer, flexible coupling and gear arrangements or other means such as belt or chain drive, or combinations thereof.

It may also be preferred that polymer solids be introduced between the rolls by a feeder (not shown) which introduces polymer solids along a line normal to the plane containing the longitudinal axes a--a and b--b, of the elongated shafts and substantially tangent to both rotating rolls 310 and 312.

In operation, a constant pressure is applied by the hydraulic cylinders 352 to bias the rolls 310 and 312 into substantially tangential contact at a point where the complementary cavities in the peripheries of the rolls 310 and 312 cooperate. The feeder introduces polymer solids into the cavities just prior to the tangential contact point. The pressure created by the polymer solids tends to force the upper roll 312 against the constant force provided by the hydraulic cylinder 352 and the polymer solids are, thereby, compressed into briquettes.

Should the quantity of particulate material between the rotating rolls 10 and 12 be greater than planned for, the release means 320 incorporated in the hydraulic cylinder 352 will release the pressure exerted by the hydraulic cylinder 352 to prevent damage to the press.

The pivot 348 allows the pivotally mounted bearing housing 320 and the upper roll 312 to move in the vertical plane defined by the axes of the elongated shafts a--a and b--b. It can be seen from the description above that, without polymer solids between the rolls, the biasing force of the hydraulic cylinders 352 and 354 would tend to bring the rolls 310 and 312 into direct contact. As the polymer solids are introduced between the rolls 310 and 312, the upper roll 312 is permitted to move in an opposite direction by use of the pivot 348.

The pressure between the rolls can vary depending on the type of polymer solids being compressed and the size of the briquettes, which can be accomplished by adjusting the force supplied by the hydraulic cylinder 352.

As the operation continues, forces tend to cause the rolls to move laterally and longitudinally relative to each other. This is prevented by the connecting rod 360 and by the pivot 348, ensuring the continuing complementary relationship of the briquette-forming cavities in the peripheries of the briquetting rolls 310 and 312.

Overall, briquettes of the present disclosure may be formed at temperatures of less than about 110 °C, such as about 70 °C to about 110 °C, such as about 80 °C to about 100 °C Pressures used for briquetting may be up to about 25,000 pounds per square inch. In some embodiments, briquettes can be formed below 500 psi, and processes of the present disclosure allow for the creation of high stability briquettes below 10,000 psi, such as about 5,000 psi to about 10,000 psi.

The briquettes can then be sintered (e.g., with a heated conveyor) to further dry and/or otherwise solidify the briquettes. Suitable methods for heat sintering are disclosed in U.S. Pat. Nos. 3,725,043, 5,264,007 or 5,302,341, incorporated by reference herein.

In some embodiments, if processing at the preferred lower temperatures doesn't yield a sufficiently compacted/stable pellet, one may have to process at higher temperatures (including up to and surpassing melting point of the polymer) in order to achieve sintering in the briquetter; or, alternatively, the pre-processed pellets can be passed from the briquetter to a sintering device for further heat/compaction to be applied. This is not necessarily preferred, but may be required for certain polymer solids that may not agglomerate sufficiently in the briquetter. Such temperatures for sintering can include those within the range of 80 °C to 150 °C Further, it is anticipated that pressure applied to the polymer during the higher-temperature sintering should be sufficient so as to avoid melting or tackiness in the equipment.

### Rolling Mill

In some embodiments, a finishing device (such as finishing device 128 of FIG. 1B) is a rolling mill used to form flattened pellets. FIG. 4 is a rolling mill 400, according to an embodiment. As shown in FIG. 4, an adjustable rolling mill 400 has a pair of adjacent rolls 401 and 402 having an adjustable gap 420 there between. The primary driven roll 401 is shown mounted in a pair of bearings 403 for rotation on a shaft 430. The driven roll 402 is likewise mounted for rotation in bearings 403′ on a shaft 431. Polymer solids (and an additive) passing in the gap 420 between the rolls will be ground, cracked, or otherwise comminuted and reduced in particle size in addition to being dried via the compression provided by adjacent rolls 401 and 402.

Main drive motor 405 rotates the driven roll 401 through a main drive V-belt drive 404. Drive of the driven roll 402 is accomplished by power takeoff from roll 401 through an extension of its shaft 430 to a V-belt drive 408 which in turn drives the driven gear box shaft 432 and through a gear reduction in the shaft mounted gear box 409 drives the driven roll shaft 431 and hence the driven roll 402.

The driven roll 402 is urged towards the driven roll 401 by a pair of precision machine screw jacks 411 which jack against the bearings 3′ through a set of strong disc springs 410. Positioning of the jack screws is accomplished by motor 417 driving the jack nut through an angle drive 416 and a coupling shaft 415 having a rigid coupling 414 which permits the simultaneous adjustment of the jack nuts and hence the extension of the jacks at both ends of the roll.

An optical encoder 418 and controller 419 with digital readout 421 permits accurate setting of the gap 420 by automatically adjusting the extension of the machine screw jacks. Parallel adjustment between the two jacks may be accomplished by a manually adjusted rigid coupling 414 and the minimum roll gap adjustment can be made manually by a hand wheel 413 or automatic remote control using the optical encode and controller.

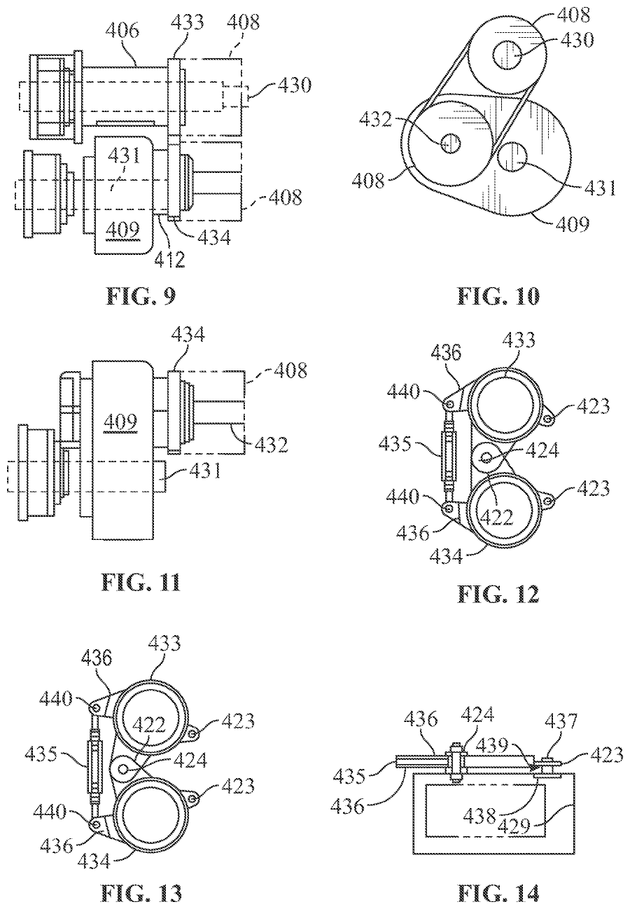

The adjustment of gap 420 may be automated. To further permit the gap adjustment, a power takeoff or interroll drive is provided. Referring to FIGS. 9 through 11, nonrotating tension base 406 is bolted to the bearing block of the driven roll 401. Mounted for rotation on the tension base 406 is a driving roll tension ring 433. A similar roll tension ring 434 is mounted for rotation on the gear box extension 412 on gear box 409. Gear box 409 has its output on a gear which drives driven roll 402 through shaft 431. Shaft mounted gear box 409 is otherwise free to rotate about shaft 431.

The V-belt drive 408 transmits power between drive roll shaft 430 and gear box shaft 432. The gear box in turn has its power output as previously mentioned on shaft 431. Referring to FIG. 10, for the roll gap 420 to change, the distance between shaft 430 and shaft 431 will similarly change. Shaft mounted gear box 409 is restrained from rotation about shaft 431, about which it is free to rotate by the belt tensioning which may be more readily understood by referring to FIGS. 12 through 14.

The belt tensioning device is comprised primarily of two tension rings: a driving roll tension ring 433 and a gear box tension ring 434. Each of these tension rings are free to rotate about the respective devices on which they are mounted, e.g., the tension base 406 which is concentric about the drive roll shaft 430 and the gear box extension 412 which is concentric about the driven gear box shaft 432. A lug 422 extends from each of the tension rings 433, 434, and are joined together by a pivot 424.

Also extending from the tension rings are a pair of fingers 436 which are operably joined together by a turnbuckle 435 attached to each of the fingers 436 by a pin 440. Referring to FIGS. 12 and 13, as the turnbuckle is extended, the rings are rotated about the tension base and the gear box extension from a position wherein the lugs 422 are positioned near the centerline providing high belt tension to a position shown in FIG. 13 when the turnbuckle is extended wherein low belt tension is provided.

Also extending from the tension rings are a pair of guard attachment lugs 423. As shown in FIG. 14, a guard 429 may be mounted to the tensioning device by a guard mounted bolt 437 and a spacer 439. The bolts cooperate with the guards 429 in a slot 438 which accommodates the required movement between the centerlines of the bolt attachment points on the guard attachment lugs 423.

Tension in the V-belt drive between the drive roll shaft 430 and the driven gear box shaft 432 may be accomplished and maintained regardless of the orientation of the tensioning device about the tension base 406 or the gear box extension 412. Since the tensioning device is free to rotate, and the gear box is also free to rotate, it may be appreciated that although the distance between the drive roll shaft and the driven gear box shaft may remain constant, to accomplish belt tension, the dog leg formed between the tensioning device and the offset of the gear box housing provides for the variation in the gap 420 between the rolls simply by rotation of the dog leg without further adjustment.

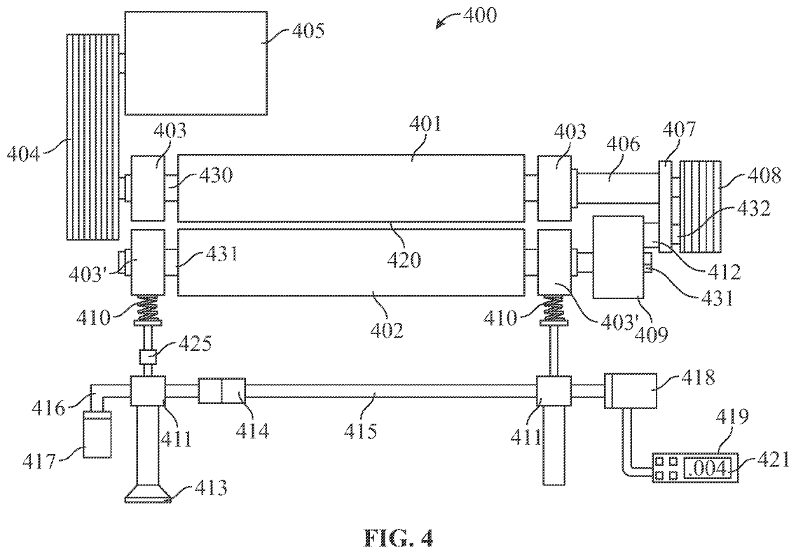

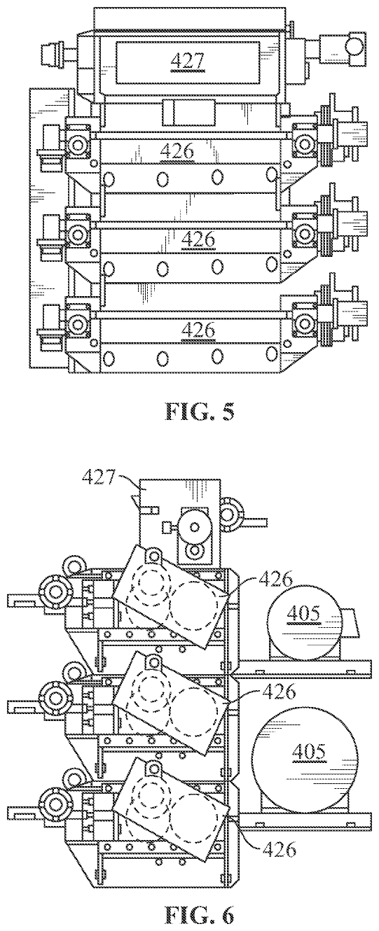

FIGS. 5 and 6 show a convenient arrangement of three roll assemblies 426 stacked in a vertical arrangement being fed by a roll feeder 427. The convenience of the roll adjusting mechanism provided according to the present disclosure and the orientation of the roll adjusting device may now be appreciated in relationship to the main drive motors.

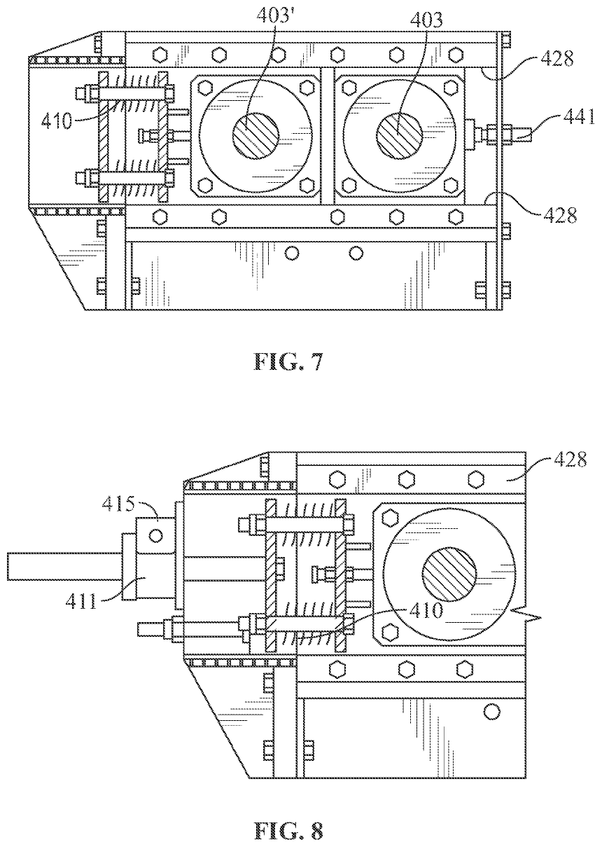

Referring to FIGS. 4, 7, and 8, the bearing mounting assembly is shown mounting the bearings 403, 403′ in a U shaped guide 428 which permits the movement of the mounting bearings towards and away from each other. Control of this movement is accomplished by lock screw 441 in the case of the drive roll bearing 403 and by the machine screw jacks 411, 415 providing force against the driven roll bearing 403′ through disc spring assembly 410. The disc spring assembly is provided to allow for the rolls to move apart to prevent damage in case of overload created, for example, by tramp material passing between the rolls. The guides 428 are formed in a U channel which permits the bearing blocks 403 and 403′ to move in a linear direction apart and conversely together.

In operation, it should be appreciated that the gap 420 may be automatically adjusted by sensing the gap by an optical encoder and adjusting the gap by setting the required gap in the controller 419 which in turn would control the motor which drives the machine screw jacks as previously described. The roll gap is accomplished without further adjustment and operation may be immediately resumed or continued during operation.

Flattened pellets of the present disclosure may be formed at temperatures of less than about 110 °C, such as about 70 °C to about 110 °C, such as about 80 °C to about 100 °C Pressures used for forming flattened pellets may be up to about 25,000 pounds per square inch. In some embodiments, pellets can be formed below 500 psi, and processes of the present disclosure allow for the creation of high stability pellets below 10,000 psi, such as about 5,000 psi to about 10,000 psi.

In some embodiments, if processing at the preferred lower temperatures doesn't yield a sufficiently compacted/stable pellet, one may have to process at higher temperatures (including up to and surpassing melting point of the polymer) in order to achieve sintering in the mill; or, alternatively, the pre-processed pellets can be passed from the mill to a sintering device for further heat/compaction to be applied. This is not necessarily preferred, but may be required for certain polymer solids that may not agglomerate sufficiently in the mill. Such temperatures for sintering can include those within the range of 80 °C all the way up to 150 °C Further, it is anticipated that pressure applied to the polymer during the higher-temperature sintering should be sufficient so as to avoid melting or tackiness in the equipment.

### Conventional Extruder and Underwater Pelletizer

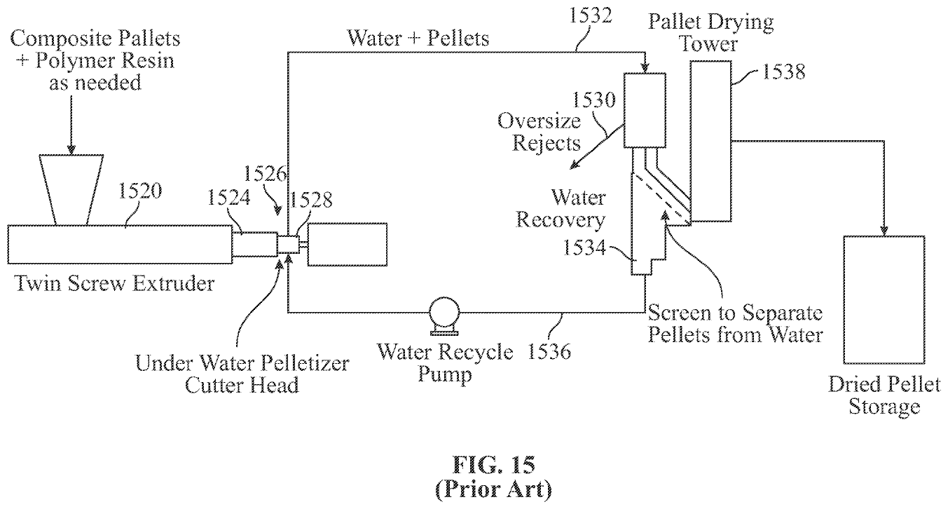

As mentioned above, processes and polymerization reactor systems of the present disclosure render conventional twin screw extruders and underwater pelletizers no longer required. Indeed, extruding and underwater pelletizing of conventional polymerization reactor systems is the most energy intensive portion of a conventional polymerization reactor system. FIG. 15 is a diagram of a conventional twin screw extruder and underwater pelletizer, according to an embodiment. Pellets exiting a die of twin screw extruder 1520 through die apertures 1524 in die plate 1526 into a cutting chamber 1528 in which the extrudate is cut into pellets. The pellets are carried by water from the cutting chamber 1528 to a separation section 1530 by pipe 1532. The hot pellets are cooled by the water. In the separation section 1530, the pellets are separated from the water by filtration. The separated water passes through a heat exchanger 1534 in which the water is cooled. The water returns to cutting chamber 1528 through pipe 1536.

The separated pellets pass through a dryer section 1538 in which the rest of the water is removed. A cyclone drier is shown but the drier can be any kind of drier. The dried pellets then pass into a pellet chute and into a bagging operation in which the pellets are bagged.

### Polymers

Processes and polymerization reactor systems of the present disclosure can be used to form a variety of polymers (that are formed into pellets or briquettes). For example, a polymer may be a polymer suitable for injection molding or blow molding applications. In some embodiments, a polymer is a polyethylene, an isotactic polypropylene, a highly isotactic polypropylene, a syndiotactic polypropylene, a random copolymer of propylene and ethylene, and/or butene, and/or hexene, polybutene, ethylene vinyl acetate, low density polyethylene (LDPE), linear low density polyethylene (LLDPE), polybutene-1, isotactic polybutene, ethylene-propylene rubber (EPR), vulcanized EPR, ethylene propylene diene monomer (EPDM) polymer, polyethylene terephthalate (PET) resins, cross linked polyethylene, copolymers of ethylene and vinyl alcohol (EVOH), polymers of aromatic monomers such as polystyrene, poly-1 esters, polyacetal, polyvinylidine fluoride, polyethylene glycols, polyisobutylene, or combination(s) thereof.

As used herein, an ethylene polymer having a density of 0.910 to 0.925 g/cm³ is referred to as a “linear low density polyethylene” (LLDPE) when substantially linear (having minor or no long chain branching) as is typically the case for Ziegler-Nata or metallocene-catalyzed PE or branched low density polyethylene (LDPE) when significantly branched (having a high degree of long chain branching), as is often the case with free-radical polymerized PE; 0.925 to 0.940 g/cm³ is referred to as a “medium density polyethylene” (MDPE); and an ethylene polymer having a density of more than 0.940 g/cm³ is referred to as a “high density polyethylene” (HDPE). Density is determined according to ASTM D792. Specimens are prepared according to ASTM D4703-Annex 1 Procedure C followed by conditioning according to ASTM D618-Procedure A prior to testing.

### High Density Polyethylene

In some embodiments, a polymer formed by processes and polymerization reactor systems of the present disclosure is a high density polyethylene. HDPEs of the present disclosure can be produced using a method of the present disclosure. In some embodiments, an HDPE has a comonomer content of about 0.01 wt% to about 5 wt%, the comonomer derived from C₃ to C₂₀ α-olefins, e.g. 1-butene or 1-hexene, and in some embodiments is a homopolymer of ethylene. In various embodiments, a density of the HDPE is from 0.94 g/cm³ to 0.97g/cm³ , such as from about 0.945 g/cm³ to about 0.965g/cm³ , or from about 0.95 g/cm³ to about 0.965g/cm³ . The HDPE may have a melt index (MI) of about 0.1g/10 min, 0.2 g/10min, or 0.4g/10 min to about 4g/10 min, 6g/10 min, or 10 g/10min. The HDPE may be prepared with either Ziegler-Natta or chromium-based catalysts in slurry reactors, gas phase reactors, or solution reactors.

In some embodiments, HDPEs of the present disclosure (and methods of making HDPEs) can be those described in U.S. Patent Publication No. 2017/0233507, incorporated herein by reference, which describes HDPEs formed using zirconium-based metallocene catalysts.

In some embodiments, an HDPE may have a density of at least about 0.950 g/cm³ and a MI, I_{2.16}, of less than about 1 g/10 min. The HDPE may further have at least one of the following properties: (i) a melting point of at least about 125 °C; (ii) a molecular weight distribution (MWD) of about 7 to about 20; and (iii) a melt index ratio (MIR), I_{21.6}/I_{2.16}, of about 45 to about 75.

In some embodiments, an HDPE may have: (i) a density of about 0.950 g/cm³ to about 0.960g/cm³ ; (ii) an MI, I_{2.16}, of about 0.15 to about 0.8; (iii)-a melting point of about 125 °C to about 135 °C; (v) an MWD of about 8 to about 15; and (iv) an MIR, I_{21.6}/I_{2.16}, of about 55 to about 70.

In some embodiments, an HDPE has a density of at least about 0.950g/cm³ , such as about 0.950 g/cm³ to about 0.970g/cm³ , such as about 0.950 g/cm³ to about 0.960g/cm³ , such as about 0.953 g/cm³ to about 0.958g/cm³ , as determined by ASTM D1505 using a density-gradient column on a compression-molded specimen that has been slowly cooled to room temperature (i.e., over a period of 10 minutes or more) and allowed to age for a sufficient time that the density is constant within +/−0.001 g/cm^{3.}

In some embodiments, an HDPE has an MI, I_{2.16}, of less than about 1.5 g/10 min, such as about 0.1 to about 0.9 g/10 min, such as about 0.4 to about 0.8 g/10 min, as measured by ASTM D1238 (190 °C, 2.16 kg).

In some embodiments, an HDPE has one or more of the following properties:
1. a Vicat softening temperature of about 110 °C to about 140 °C, such as about 120 °C to about 130 °C, such as about 125 °C to about 128 °C, as determined by ASTM D1525; and/or
2. a tensile strength at break (MD) of about 8,000 psi to about 10,000 psi, such as about 8,500 psi to about 9,000 psi, such as about 8,700 psi, as determined by ASTM D882-10; and/or
3. a tensile strength at break (TD, 20 in/min) of about 3,500 psi to about 5,500 psi, such as about 4,250 psi to about 4,750 psi, such as about 4,500 psi, as determined by ASTM D882-10; and/or
4. an elongation at break (MD, 20 in/min) of about 400% to about 600%, such as about 475% to about 525%, such as about 510%, as determined by ASTM D882; and/or
5. an elongation at break (TD, 20 in/min) of about 0.5% to about 5%, such as about 1% to about 3%, such as about 2%, as determined by ASTM D882; and/or
6. a secant modulus MD (1% secant) of about 125,000 psi to about 250,000 psi, such as about 150,000 psi to about 200,000 psi, such as about 160,000 psi to about 180,000 psi, such as about 170,000 psi, as determined by ASTM D882; and/or
7. a secant modulus TD (1% secant) of about 150,000 psi to about 450,000 psi, such as about 200,000 psi to about 400,000 psi, such as about 225,000 psi to about 275,000 psi, such as about 250,000 psi, as determined by ASTM D882; and/or
8. a dart drop impact of about 30 grams or less, as determined by ASTM D1709A; and/or
9. an Elmendorf Tear Strength (MD) of about 3 g to about 20 g, such as about 5 g to about 15 g, such as about 8 g to about 12 g, such as about 9 g to about 11 g, such as about 10 g, as determined by ASTM D1922; and/or
10. an Elmendorf Tear Strength (TD) of about 150 g to about 250 g, such as about 175 g to about 225 g, such as about 190 g to about 210 g, such as about 200 g, as determined by ASTM D1922.

It will be realized that the HDPE described herein can be utilized alone or admixed with other polyethylene polymers of the class described herein in order to obtain desired properties. In some embodiments, the HDPE is an ethylene homopolymer.

Chromium-based catalysts, such as those modified with aluminum alkyls, are known for polymerization in slurry reactions and may be suitable for making the HDPE. See, for instance, U.S. Patent Publication No. 2020/0055966 for discussion of some suitable chromium catalysts. In other embodiments, in connection with slurry, gas phase, or other polymerization, the HDPE can be made using any suitable metallocene catalyst.

Processes and polymerization reactor systems of the present disclosure can be used to provide any suitable commercial polymer for an HDPE such as those sold by ExxonMobil Chemical Company in Houston Tex., including HDPE HD and HDPE HTA and those sold under the trade names PAXON™ (ExxonMobil Chemical Company, Houston, Texas, USA); CONTINUUMTM, DOW™, DOWLEX™, and UNIVAL™ (The Dow Chemical Company, Midland, Michigan, USA). Commercial HDPE is available with a density range such as 0.94 g/cm³ to 0.97 g/cm³ and melt index (MI) range such as 0.06 g/10 min. to 33 g/10 min. HDPE polymers may include:
ExxonMobil™ HDPE HTA 108 resin has an MI of 0.70 g/10 min and density of 0.961 g/cm3, and is commercially available from ExxonMobil Chemical Company, Houston, Texas.
PAXON™ AA60-003 resin has an MI of 0.25 g/10 min and density of 0.963g/cm³ , and is commercially available from ExxonMobil Chemical Company, Houston, Texas.
CONTINUUM™ DMDA-1260 resin has an MI of 2.7 g/10 min and density of 0.963 g/cm3, and is commercially available from Dow Chemical Company, Midland, Michigan.
UNIVAL™ DMDA-6147 resin has an MI of 10 g/10 min and density of 0.948g/cm³ , and is commercially available from Dow Chemical Company, Midland, Michigan.

Overall, processes and polymerization reactor systems of the present disclosure can take granular products from a reactor uniformly distribute additives therewith and form pellets for distribution and further use as polymer products. The polymer from a reactor (and/or one or more separation systems) feeds into a finishing device (e.g., a pellet mill, a briquetter, or a rolling mill) which will extrude with pressure and without substantial (e.g., complete) melting of the polymer through a capillary. As the product flows through a capillary it can be cut or broken to a desired shape. Such processes are designed to compact the product. Briquetting machines may also be used to compact the product into a shape directly without flow through a capillary. In some cases, the outside surface of a pellet or briquette may be subjected to sintering to increase the strength and reduce the brittleness of the pellet/briquette. The inventors have found that by utilizing compaction, briquetting, and/or sintering of polymer solids from a polymerization reactor system, polymer solids can be pelletized with a large reduction in energy usage (e.g., 80% reduction or more) while maintaining an ability to incorporate additives into the polymer pellet (e.g., maintaining 80-90% mixing efficiency as compared to an extruder). In addition, because the polymer solid is not taken to a melt phase (unlike with conventional extruders), the integrity of the chemical structure of the polymer itself (and/or additives) is maintained due to reduced thermal stresses on the polymer (and/or additives) as compared to conventional extruders utilizing a polymer melt. In the case of additives, a reduced amount of additives may be used due to the reduced degradation of the additives in processes and polymerization reactor systems of the present disclosure. Also, due to the reduced thermal input, a reduced or eliminated amount of nitrogen can be used in processes of the present disclosure due to reduced oxidation of polymer and/or additives which provides reduced discoloration (e.g., yellowness) of the polymer products.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of embodiments of the present disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

All priority documents are herein fully incorporated by reference for all jurisdictions in which such incorporation is permitted and to the extent such disclosure is consistent with the description of the present disclosure. Further, all documents and references cited herein, including testing procedures, publications, patents, journal articles, etc. are herein fully incorporated by reference for all jurisdictions in which such incorporation is permitted and to the extent such disclosure is consistent with the description of the present disclosure.

While the present disclosure has been described with respect to a number of embodiments and examples, those skilled in the art, having benefit of this disclosure, will appreciate that other embodiments can be devised which do not depart from the scope and spirit of the present disclosure.

What is claimed is:

1. A process for preparing a polymer pellet or a polymer briquette, the process comprising:
introducing a monomer, a catalyst, and a diluent into a reactor under polymerization conditions to form a polymer; and
introducing the polymer to a finishing device selected from the group consisting of a pellet mill, a rolling mill, a briquetter, or a combination thereof to form the polymer pellet or the polymer briquette.

2. The process of claim 1, further comprising introducing a comonomer into the reactor, wherein the polymer is a copolymer.

3. The process of claim 2, wherein the diluent comprises isobutane.

4. The process of claim 1, wherein the catalyst is a supported catalyst and the reactor is a loop reactor

5. The process of claim 1, further comprising introducing the polymer from the reactor to a flash tank before introducing the polymer to the finishing device, to separate a vaporized liquid from the polymer.

6. The process of claim 5, further comprising introducing the polymer from the flash tank to a second flash tank before introducing the polymer to the finishing device, to separate a second vaporized liquid from the polymer.

7. The process of claim 1, wherein the finishing device is the pellet mill.

8. The process of claim 7, wherein introducing the polymer to the pellet mill comprises introducing the polymer to a feed bin of the pellet mill and then into a feed conveyor of the pellet mill.

9. The process of claim 8, wherein introducing the polymer to the pellet mill further comprises introducing the polymer from the feed conveyor to a conditioner vessel and mixing the polymer with an additive in the conditioner vessel to form a mixture.

10. The process of claim 9, wherein introducing the polymer to the pellet mill further comprises introducing the mixture from the conditioner vessel to the pelletizing mill and forcing the mixture through apertures in a pelletizing die disposed within the pelletizing mill to form the polymer pellet.

11. The process of claim 10, wherein mixing the polymer with the additive and forcing the mixture through the apertures are each performed at a temperature of the mixture that is less than a melt temperature of the polymer.

12. The process of claim 10, further comprising introducing the polymer pellet into a pellet cooler.

13. The process of claim 10, wherein forcing the mixture through the apertures in the pelletizing die comprises sintering the mixture into agglomerated pellets.

14. The process of claim 1, wherein the finishing device is the briquetter.

15. The process of claim 14, wherein introducing the polymer to the briquetter comprises:
introducing the polymer and an additive to a tank of the briquetter, the tank comprising a screw mounted in the tank, and
rotating the screw to promote mixing of the polymer and the additive to form a mixture.

16. The process of claim 15, further comprising introducing the mixture into a shaping chamber and moving a press ram to form the polymer briquette.

17. The process of claim 16, wherein rotating the screw and moving the press ram are each performed at a temperature of the mixture that is less than a melt temperature of the polymer.

18. The process of claim 16, wherein forming the polymer briquette takes place at a temperature of the mixture such that the mixture is sintered to form the polymer briquette.

19. The process of claim 1, wherein the finishing device is the rolling mill.

20. The process of claim 19, wherein introducing the polymer to the rolling mill comprises introducing the polymer and an additive through a gap disposed between a pair of adjacent rolls and rolling the adjacent rolls to form the polymer pellet, wherein the polymer pellet is a flattened pellet.

21. The process of claim 20, wherein introducing the polymer through the gap and rolling the adjacent rolls are each performed at a temperature of the polymer pellet that is less than a melt temperature of the polymer.

22. The process of claim 20, further comprising sintering the flattened pellet.

23. The process of claim 1, wherein the polymer is a polyethylene copolymer having a density of about 0.88 g/cm³ or greater

24. The process of claim 23, wherein the polyethylene copolymer has a density of about 0.94 g/cm³ or greater and a comonomer content of about 0.01 wt % to about 5 wt % and a comonomer that is 1-butene or 1-hexene.

25. The process of claim 24, wherein the density of the polyethylene copolymer is from about 0.95 g/cm³ to about 0.97g/cm³ .
